(19) United States
(12) Patent Application Publication
(10) Pub. No.: US 2010/0293807 A1
(43) Pub. Date: Nov. 25, 2010

(54) VERTICAL PATCH DRYING

(75) Inventors: Yossi Bar-El, Beit Arye (IL); Giora Arbel, Tel Mond (IL); Meir Stern, Rehovot (IL)

Correspondence Address: SUGHRUE MION, PLLC, 2100 PENNSYLVANIA AVENUE, N.W., SUITE 800, WASHINGTON, DC, 20037, US

(73) Assignee: TRANSPHARMA MEDICAL, LTD., Lod (IL)

(21) Appl. No.: 12/740,184

(22) PCT Filed: Oct. 29, 2008
(86) PCT No.: PCT/IL2008/001427

§ 371 Date: Jul. 19, 2010

Related U.S. Application Data
(60) Provisional application No. 61/001,016, filed on Oct. 29, 2007.

(51) Int. Cl. F26B 21/08; F26B 21/00; F26B 5/00

(52) U.S. Cl. 34/282; 34/557; 34/523

(57) ABSTRACT

Apparatus is provided, including one or more drug patches (20) and a surface (22) configured to hold the one or more drug patches. A housing (24) is shaped to define one or more gas inflow openings (30) that are configured to facilitate drying of the patches by directing a flow of a gas toward the patches, a midline of the flow being at an angle of less than 20 degrees from a normal to the surface. Other embodiments are also described.

### CROSS-REFERENCES TO RELATED APPLICATIONS

The present application claims the benefit of U.S. Provisional Patent Application 61/001,016 to Bar-El et al., filed Oct. 29, 2007, entitled, “Vertical patch drying,” which is incorporated herein by reference.

### FIELD OF THE INVENTION

The present invention generally relates to medical apparatus and methods. Specifically, the present invention relates to dissolvable drug patches.

### BACKGROUND OF THE INVENTION

In recent years many drugs have been formulated for transdermal delivery. Transdermal delivery of drugs is the favored delivery method for many patients, particularly for those who find it difficult to have drugs administered to them orally or via an injection.

US Patent Application Publication 2004/0137044 to Stern et al., which is incorporated herein by reference, describes a system for transdermal delivery of dried or lyophilized pharmaceutical compositions and methods for using the system. The system comprises an apparatus for facilitating transdermal delivery of an agent that generates hydrophilic micro-channels, and a patch comprising a therapeutically active agent. The system is described as being useful for transdermal delivery of hydrophilic agents, particularly of high molecular weight proteins.

U.S. Pat. No. 5,983,135 to Avrahami, which is incorporated herein by reference, describes a device for delivery of a powder to the skin of a subject which includes a pad, made of an insulating material and having an upper side and a lower side, which lower side is placed against the skin after application of the powder thereto. An electrical power source applies an electrical potential to the pad, causing the powder to adhere by electrostatic force to the lower side of the pad, and then alters the potential so that the powder is released from the pad and contacts the skin against which the pad is placed.

U.S. Pat. No. 7,097,850 to Chappa et al., relevant portions of which are incorporated herein by reference, describes a coating composition in the form of a one or multi-part system, and method of applying such a composition under conditions of controlled humidity, for use in coating device surfaces to control and/or improve their ability to release bioactive agents in aqueous systems. The coating composition is particularly adapted for use with medical devices that undergo significant flexion and/or expansion in the course of their delivery and/or use, such as stents and catheters. The composition includes the bioactive agent in combination with a first polymer component such as polyalkyl(meth)acrylate, polyaryl(meth)acrylate, polyaralkyl(meth)acrylate, or polyaryloxyalkyl(meth)acrylate and a second polymer component such as poly(ethylene-co-vinyl acetate).

U.S. Pat. No. 6,932,983 to Straub et al., relevant portions of which are incorporated herein by reference, describes drugs, especially low aqueous solubility drugs, which are provided in a porous matrix form, preferably microparticles, which enhances dissolution of the drug in aqueous media. The drug matrices preferably are made using a process that includes (i) dissolving a drug, preferably a drug having low aqueous solubility, in a volatile solvent to form a drug solution, (ii) combining at least one pore forming agent with the drug solution to form an emulsion, suspension, or second solution, and (iii) removing the volatile solvent and pore forming agent from the emulsion, suspension, or second solution to yield the porous matrix of drug. The pore forming agent can be either a volatile liquid that is immiscible with the drug solvent or a volatile solid compound, preferably a volatile salt. In a preferred embodiment, spray drying is used to remove the solvents and the pore forming agent. The resulting porous matrix is described as having a faster rate of dissolution following administration to a patient, as compared to non-porous matrix forms of the drug. In a preferred embodiment, microparticles of the porous drug matrix are reconstituted with an aqueous medium and administered parenterally, or processed using standard techniques into tablets or capsules for oral administration.

Alza Corporation (CA, USA) has developed “Macroflux®” products, which are described as incorporating a thin titanium screen with precision microprojections which, when applied to the skin, create superficial pathways through the skin's dead barrier layer allowing transport of macromolecules. Macroflux® products provide the option of dry-coating the drug on the Macroflux® microprojection array for bolus delivery into the skin or using a drug reservoir for continuous passive or electrotransport applications. In addition, the creation of Macroflux® pathways is described as allowing for better control of drug distribution throughout the skin patch treatment area and reduction in potential skin irritation.

The following patents and patent applications, relevant portions of which are incorporated herein by reference, may be of interest:

U.S. Pat. No. 6,855,372 to Trautman et al.

US Patent Application Publication 2004/0059282 to Flock et al.

U.S. Pat. No. 5,685,837 to Horstmann

U.S. Pat. No. 5,230,898 to Horstmann et al.

U.S. Pat. No. 6,522,918 to Crisp et al.

U.S. Pat. No. 6,374,136 to Murdock

U.S. Pat. No. 6,251,100 to Flock et al.

US Patent Application Publication 2003/0204163 to Marchitto et al.

U.S. Pat. No. 5,141,750 to Lee et al.

U.S. Pat. No. 6,248,349 to Suzuki et al.

PCT Publication WO 05/088299 to Tsuji et al.

The following references, relevant portions of which are incorporated herein by reference, may be of interest:

Patel et al., “Fast Dissolving Drug Delivery Systems: An Update,” Pharmainfo.net (July 2006)

Holman J P, “Heat Transfer,” McGraw-Hill Inc., USA (1976)

### SUMMARY OF THE INVENTION

In some embodiments of the present invention, a drug, in liquid form, is applied to a patch. The patch is then placed, substantially flat, on a surface, and is dried by normal flow drying, i.e., a flow of gas is directed toward the patch, the midline of the flow being at an angle of less than 20 degrees from the normal to the surface, e.g., less than 10 degrees.

In some embodiments, for a given amount of gas, normal flow drying allows for the patches to be dried at a greater rate than if the patches were dried by directing a flow of gas toward the patches the midline of which flow is at an angle of greater than 20 degrees from a normal to the surface, i.e. by non-normal flow drying. (Nevertheless, it may be that for some applications, normal flow drying dries the patches at a rate that is equal to, or lower than, if the patches were dried by non-normal flow drying.) Typically, drying the patch using normal flow drying uses less gas than is used for non-normal flow drying. (Nevertheless, it may be that for some applications, an equal or greater amount of gas is used for the normal flow drying.) In some embodiments, normal flow drying reduces a chance of a patch being displaced from its position on the surface.

Typically, air, and/or an inert gas, is directed through openings toward the patches. In some embodiments, the openings are shaped to define nozzles, and jets of gas are directed toward the patches.

In some applications, the humidity of the gas which is directed toward the patches is controlled. The humidity of the gas with which the patches are dried may have an effect on the ultimate dissolution properties of the drug when the patch is placed on the moistened skin of a user. Alternatively or additionally, the humidity of the gas is controlled for a different reason, e.g., lower humidity increases the rate of drying.

In some embodiments, an array of patches are placed on the surface and an array of jets direct the gas toward the array of patches. In some applications, the array of patches is stationary and is disposed inside a chamber during the drying of the patches. A jet of gas is directed toward each respective patch of the array. Alternatively, the array of patches is moved through the chamber during the drying. For example, the surface may comprise a conveyor belt. The patches are placed on the conveyor belt and the conveyor belt moves the patches through the drying chamber during the drying. In some embodiments, the surface moves during the drying and the jets are configured to direct the gas toward the patches only when the patches are disposed underneath respective jets.

In some embodiments, the openings do not define nozzles, or the openings define nozzles but the nozzles do not direct jets toward respective patches. In accordance with these embodiments, the gas is directed in the direction of the patches, but not toward individual patches. For example, the gas may be directed toward the patches by passing high pressure air through holes in a surface.

There is therefore provided in accordance with an embodiment of the invention, apparatus, including:

one or more drug patches;

a surface configured to hold the one or more drug patches; and

a housing shaped to define one or more gas inflow openings that are configured to facilitate drying of the patches by directing a flow of a gas toward the patches, a midline of the flow being at an angle of less than 20 degrees from a normal to the surface.

In an embodiment, the gas includes room air and the one or more gas inflow openings are configured to direct the air toward the patches.

In an embodiment, the gas consists essentially of an inert gas and the one or more gas inflow openings are configured to direct the inert gas toward the patches.

In an embodiment, the housing is shaped to define the one or more openings as one or more nozzles configured to dry the patches by directing jets of the gas toward the patches, midlines of the respective jets of gas being at an angle of less than 20 degrees from the normal.

In an embodiment, the apparatus includes a pressure source configured to pump the gas through the openings at a speed of between 3 m/s and 15 m/s.

In an embodiment, the pressure source is configured to pump the gas through the openings at a speed of between 6 m/s and 12 m/s.

In an embodiment, the openings have diameters that are between 0.5 mm and 7 mm.

In an embodiment, the openings have diameters that are between 2 mm and 5 mm.

In an embodiment, the openings are configured to direct the gas toward the patches from a distance of between 0.5 cm and 7 cm from the patches.

In an embodiment, the openings are configured to direct the gas toward the patches from a distance of between 2 cm and 5 cm from the patches.

In an embodiment, the apparatus includes a humidity controller configured to control a humidity of the gas.

In an embodiment, the humidity controller is configured to maintain the humidity of the gas between 2% and 20% relative humidity during drying of the one or more drug patches.

In an embodiment, the humidity controller is configured to maintain the humidity of the gas between 5% and 10% relative humidity during drying of the one or more drug patches.

In an embodiment, the apparatus includes a humidity detector configured to detect a humidity of the gas.

In an embodiment, the apparatus includes a control unit configured to modulate the humidity of the gas in response to the detected humidity.

In an embodiment, the one or more drug patches include an array of drug patches, the surface is configured to hold the array of patches, and the gas inflow openings are configured to dry the array of patches.

In an embodiment, the surface is configured to be stationary during drying of the patches.

In an embodiment, the surface is configured to move the array of patches during drying of the patches.

In an embodiment, the gas inflow openings are arranged to define an array of nozzles configured to dry the patches by directing a respective jet of the gas toward each patch, midlines of the respective jets being at an angle of less than 20 degrees from a normal to the surface.

In an embodiment, the number of patches in the array of patches is equal in number to the number of nozzles in the array of nozzles.

In an embodiment, each nozzle is disposed so as to direct the gas toward a respective one of the patches.

In an embodiment, the surface is configured to move the array of patches intermittently, and the nozzles are configured to direct the gas during periods between the intermittent moving of the array.

There is further provided, in accordance with an embodiment of the present invention, a method for preparing a drug patch, including:

applying a drug in liquid form to a patch;

placing the patch on a surface; and

drying the patch by directing a flow of a gas toward the patch, a midline of the flow being at an angle of less than 20 degrees from a normal to the surface.

In an embodiment, the method further includes controlling a humidity of the gas.

In an embodiment, the gas includes room air, directing the flow of the gas toward the patch includes directing the air toward the patch, and controlling the humidity of the gas includes controlling a humidity of the air.

In an embodiment, the gas consists essentially of an inert gas, directing the flow of the gas toward the patch includes directing the inert gas toward the patch, and controlling the humidity of the gas includes controlling a humidity of the inert gas.

The present invention will be more fully understood from the following detailed description of embodiments thereof, taken together with the drawings, in which:

### BRIEF DESCRIPTION OF THE DRAWINGS

FIG. 1 is a schematic illustration of an array of drug patches being dried, in accordance with an embodiment of the invention;

FIG. 2 is a schematic illustration of a moving array of drug patches being dried by jets, in accordance with an embodiment of the invention; and

FIG. 3 is a schematic illustration of a moving array of drug patches being dried, in accordance with another embodiment of the invention.

### DETAILED DESCRIPTION OF EMBODIMENTS

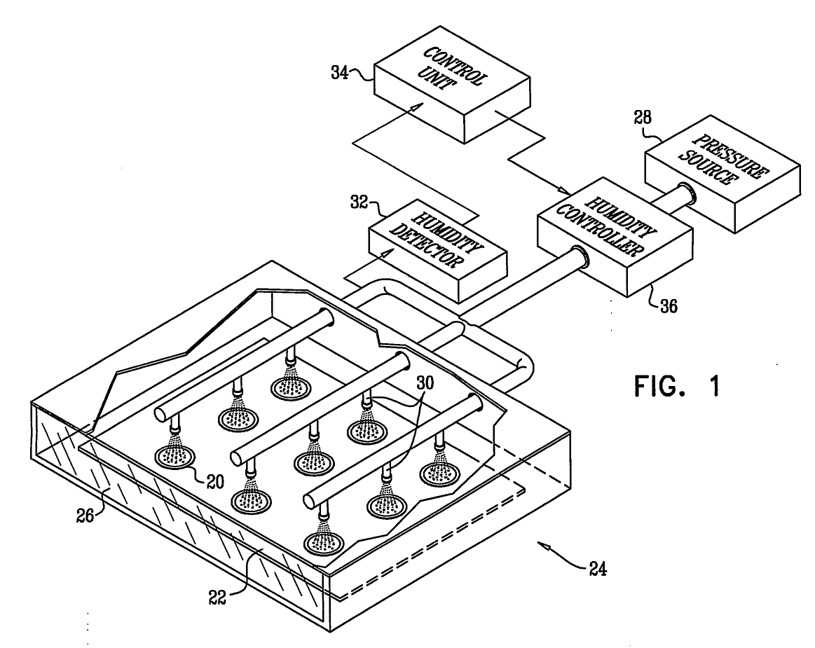

Reference is now made to FIG. 1, which is a schematic illustration of an array of drug patches 20, being dried in accordance with an embodiment of the invention. The drug patches are arranged on a surface 22, which is placed inside a drying chamber 24 and remains stationary during the drying. In some embodiments, the opening of the drying chamber is covered with a cover 26 during the drying. A pressure source 28 pumps a gas out of an array of openings 30, the openings being configured to direct a flow of the gas toward the patches, the midline of the flow being at an angle of less than 20 degrees from the normal to the surface. (The angles shown in FIG. 1 are substantially zero degrees from the normal.) Typically, the gas comprises air and/or an inert gas. In some embodiments, each opening directs the gas toward a respective patch, as shown in FIG. 1.

In some embodiments, the humidity of the gas with which the patches are dried is controlled. Typically, as shown in FIG. 1, the gas passes through a humidity controller 36. Typically, the humidity controller is configured to maintain the humidity of the gas between 2% and 20% relative humidity. In some embodiments, the controller maintains the humidity between 5% and 10% relative humidity. For some applications, a humidity detector 32 detects the humidity of the gas, or the humidity of the environment in which the patches are dried, for example, the room or the drying chamber in which the patches are dried. A control unit 34 regulates the humidity of the gas, via the humidity controller, in response to the detected humidity.

Experiments are described hereinbelow that evaluated the dissolution properties of patches dried in controlled environments with respective relative humidity levels. It was observed by the inventors that drying the patches in conditions of lower relative humidity results in patches having substantially superior dissolution properties. Subsequently, experiments were conducted by the inventors, in which the humidity of the gas which was used to dry the patches was controlled. It was observed that patches dried with a gas having a relative humidity of between 5% and 10% had good dissolution properties.

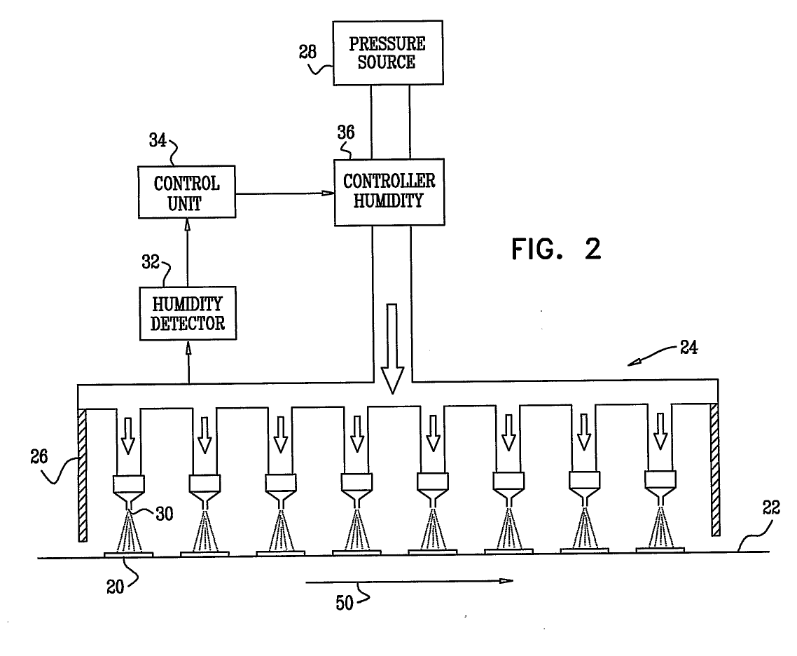

Reference is now made to FIG. 2, which is a schematic illustration of an array of drug patches 20 being dried, in accordance with an embodiment of the invention. Although only one row of patches is shown, in some embodiments the array comprises a plurality of rows. The patches are configured to move inside the drying chamber, arranged in an array on surface 22. For example, surface 22 may comprise the surface of a conveyor belt. Prior to the drying, the patches are arranged in an array on the surface, and the surface then moves inside the drying chamber. The direction of motion of the surface is indicated by arrow 50.

In some embodiments, the openings are shaped to define nozzles, as shown in FIG. 2. Typically, the nozzles are pneumatic adjustable valves, for example, those manufactured by Pisco Pneumatic Equipments LTD (model no. JNC4-01). The nozzles are configured to direct jets of gas toward respective patches, during the drying of the patches. In some embodiments, surface 22 remains stationary during the drying of the patches. Alternatively, surface 22 moves through the chamber during the drying, and the jets are configured to direct the gas toward the patches only when each patch is aligned with a respective jet. The patches are moved out of the drying chamber, subsequent to the drying, in the direction of arrow 50.

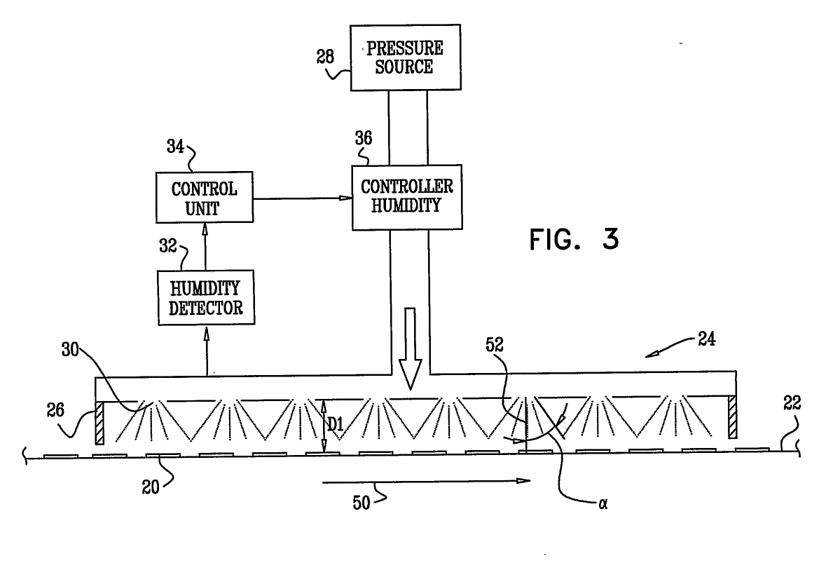

Reference is now made to FIG. 3, which is a schematic illustration of an array of drug patches 20 being dried, in accordance with an embodiment of the invention. The patches are arranged on surface 22 which moves in the direction of arrow 50 during the drying of the patches. Although only one row of patches is shown, in some embodiments the array comprises a plurality of rows. The inner, upper surface of drying chamber 24 is shaped to define openings 30 which direct respective flows of gas into the drying chamber and toward the patches, the midline of the respective gas flows being at an angle that is less than 20 degrees from the normal to the surface. Typically, the gas is directed toward the patches at a speed of between 3 m/s and 15 m/s, e.g., between 6 m/s and 12 m/s. The openings direct the gas in the direction of the patches, but not toward individual patches. In such embodiments, there is overlap of the gas flow coming out of adjacent nozzles. Typically, a divergence alpha from a midline 52 of each of the jets is between 10 degrees and 30 degrees, e.g. between 15 degrees and 25 degrees. Openings 30 typically have a diameter of between 0.5 mm and 7 mm, e.g., between 2 mm and 5 mm. Distance D1, from the openings to the patches is typically between 0.5 cm and 7 cm, e.g., between 2 cm and 5 cm.

In some embodiments, the patches are arranged on surface 22, and surface 22 moves through the drying chamber in a continuous, assembly-line-like fashion. Control unit 34 is configured to control the movement of the surface and the directing of the gas through the openings. For some applications, the control unit is configured to control the movement of the surface or the directing of the gas responsively to the humidity detected by humidity detector 32.

Experiments were conducted to investigate the effect of the humidity of the environment in which drug patches are dried on their ultimate dissolution properties. Patches were printed with 50 micrograms of hPTH(1-34) (human parathyroid hormone) by applying a 10 mg/ml hPTH solution to each patch. Patches were dried at 25 C for 3 hours in a climatic chamber under two relative humidity levels:

1. Five patches were dried at 84% relative humidity controlled conditions.

2. Five patches were dried at 45% relative humidity controlled conditions.

Following 3 hours drying inside the climatic chamber, the patches were packed in a pouch filled with argon gas and containing a silica gel sachet, and transferred into a room held at 4 C.

A third group of five patches was dried at 25 C under conditions of approximately 1.5% relative humidity. Such conditions were created by placing the patches inside sealed laminated pouches with silica gel immediately after the printing of the patches.

The dissolution properties of the patches were analyzed after 3 days and after 7 days, using trifluoroacetic acid/high performance liquid chromatography (TFA-HPLC) analysis. The results are presented in Table 1.

TABLE 1
Dissolution results for hPTH drug patches
dried in conditions of controlled humidity

hPTH release
(% of quantity initially
dried onto the patch)

| Conditions | 3 Days | 7 Days |
|---|---|---|
| 84% RH/25 C. | 55.9 ± 7.6 | 55.3 ± 4.5 |
| 45% RH/25 C. | 89.4 ± 2.8 | 88.2 ± 1.9 |
| ~1.5% RH/25 C. | 88.3 ± 1.1 | 90.8 ± 1.9 |

(± indicates standard deviation)

The results indicate that drying the patches in conditions of lower relative humidity results in patches having improved dissolution properties.

A further experiment was conducted, in which a batch of 24 patches was printed with 90 micrograms of hPTH(1-34). The patches were dried using drying techniques that are known in the art, in an environment having a controlled humidity of between 30% RH/25 C and 45% RH/25 C. The drying time of the patches was measured and the patches were found to have drying times of between 30 and 50 minutes. The dissolution properties of five of the patches were analyzed after the patches had been stored in pouches containing a silica gel sachet, inside a room at 4 C for one week. The patches released a mean of 85.1%±3.5% of the quantity of hPTH(1-34) that was initially dried onto the respective patches. The dissolution properties of five of the remaining patches of the batch of patches were analyzed after the remaining patches had been stored in pouches containing a silica gel sachet, inside a room at 4 C for one month. The patches released a mean of 83.0%±4.1% of the quantity of hPTH(1-34) that was initially dried onto the respective patches.

In still further experiments, the inventors analyzed 50 patches that were dried using normal flow drying techniques, as described hereinabove. The patches that were analyzed were hPTH(1-34) patches, having either 50 micrograms or 80 micrograms of the drug dried onto them. The patches were dried with dried air having a relative humidity of between 5% RH/25 C and 10% RH/25 C. The mean drying time of the patches under these conditions was less than 4 minutes. All of the patches released between 80% and 90% of the quantity of hPTH(1-34) that was initially dried onto the respective patches. In addition, the patches were found to release less than 5% degradation products, as were patches dried by the alternative methods described above with reference to the other experiments. These results indicated to the inventors that drying patches using normal flow drying, and using dried air, produces patches having suitable dissolution properties in a relatively short time.

In an embodiment of the invention, a row of patches passes through a drying chamber on a conveyor belt which is continually operated as part of a drug patch manufacturing line. Dried air having a humidity of between 5% RH/25 C and 10% RH/25 C is directed toward the conveyor belt with normal flow. Under these conditions, each of the patches dries in approximately four minutes (actual time being dependent on a number of factors). In an embodiment, the conveyor belt moves with a speed of 1 m/minute and the conveyor belt is 4 meters long. Round patches having a diameter of 2 cm, or square patches having a length of 2 cm, are arranged on the conveyor belt such that there are 50 patches arranged along each meter of the conveyor belt. Each minute, 50 dry patches that have been dried on the conveyor belt pass to the next stage of the manufacturing line. In some embodiments, more than one row of patches are arranged on the conveyor belt, for example, four rows of patches may be arranged adjacently on the conveyor belt, such that 200 patches are dried per minute.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. Apparatus, comprising:
one or more drug patches;
a surface configured to hold the one or more drug patches; and
a housing shaped to define one or more gas inflow openings that are configured to facilitate drying of the patches by directing a flow of a gas toward the patches, a midline of the flow being at an angle of less than 20 degrees from a normal to the surface.

2-3. (canceled)

4. The apparatus according to claim 1, wherein the housing is shaped to define the one or more openings as one or more nozzles configured to dry the patches by directing jets of the gas toward the patches, midlines of the respective jets of gas being at an angle of less than 20 degrees from the normal.

5. The apparatus according to claim 1, and comprising a pressure source configured to pump the gas through the openings at a speed of between 3 m/s and 15 m/s.

6. (canceled)

7. The apparatus according to claim 1, wherein the openings have diameters that are between 0.5 mm and 7 mm.

8. (canceled)

9. The apparatus according to claim 1, wherein the openings are configured to direct the gas toward the patches from a distance of between 0.5 cm and 7 cm from the patches.

10. (canceled)

11. The apparatus according to claim 1, and comprising a humidity controller configured to control a humidity of the gas.

12. The apparatus according to claim 11, wherein the humidity controller is configured to maintain the humidity of the gas between 2% and 20% relative humidity during drying of the one or more drug patches.

13. The apparatus according to claim 12, wherein the humidity controller is configured to maintain the humidity of the gas between 5% and 10% relative humidity during drying of the one or more drug patches.

14. (canceled)

15. The apparatus according to claim 1, further comprising a humidity detector configured to detect a humidity of the gas, and a control unit configured to modulate the humidity of the gas in response to the detected humidity.

16. The apparatus according to claim 1, wherein the one or more drug patches comprise an array of drug patches, wherein the surface is configured to hold the array of patches, and wherein the gas inflow openings are configured to dry the array of patches.

17. The apparatus according to claim 16, wherein the surface is configured to be stationary during drying of the patches.

18. The apparatus according to claim 16, wherein the surface is configured to move the array of patches during drying of the patches.

19. The apparatus according to claim 16, wherein the gas inflow openings are arranged to define an array of nozzles configured to dry the patches by directing a respective jet of the gas toward each patch, midlines of the respective jets being at an angle of less than 20 degrees from a normal to the surface.

20. The apparatus according to claim 19, wherein the number of patches in the array of patches is equal in number to the number of nozzles in the array of nozzles.

21. (canceled)

22. The apparatus according to claim 19, wherein the surface is configured to move the array of patches intermittently, and wherein the nozzles are configured to direct the gas during periods between the intermittent moving of the array.

23. A method for preparing a drug patch, comprising:
applying a drug in liquid form to a patch;
placing the patch on a surface; and
drying the patch by directing a flow of a gas toward the patch, a midline of the flow being at an angle of less than 20 degrees from a normal to the surface.

24. The method according to claim 23, wherein directing the flow of the gas toward the patch comprises directing a jet of gas toward the patch.

25-26. (canceled)

27. The method according to claim 23, wherein directing the flow of the gas comprises directing the flow of the gas through an opening which has a diameter of between 0.5 mm and 7 mm.

28. (canceled)

29. The method according to claim 23, wherein directing the flow of the gas comprises directing the flow of the gas through an opening that is at a distance of between 0.5 cm and 7 cm from the patch.

30. (canceled)

31. The method according to claim 23, wherein directing the flow of the gas toward the patch comprises directing the flow of the gas toward the patch at a speed of between 3 m/s and 15 m/s.

32. (canceled)

33. The method according to claim 23, further comprising controlling a humidity of the gas.

34-35. (canceled)

36. The method according to claim 33, wherein controlling the humidity of the gas comprises maintaining the humidity of the gas at a level that is between 2% and 20% relative humidity.

37. The method according to claim 36, wherein controlling the humidity of the environment comprises maintaining the humidity of the gas at a level that is between 5% and 10% relative humidity.

38. (canceled)

39. The method according to claim 23, further comprising detecting a humidity of the gas, and modulating the humidity of the gas responsively to the detected humidity.

40. The method according to claim 23, wherein the patch includes an array of patches, wherein placing the patch on the surface comprises placing the array of patches on the surface, and wherein directing the flow of the gas toward the patch comprises directing the flow of the gas toward the array of patches.

41. The method according to claim 40, wherein drying the array of patches comprises drying the array while the array is stationary.

42. The method according to claim 40, and comprising moving the array of patches during the directing of the gas toward the array.

43. The method according to claim 40, and comprising moving the array intermittently, wherein directing the flow of the gas comprises directing the flow of the gas during periods between the intermittent moving of the array.

44. The method according to claim 40, wherein directing the flow of the gas toward the array of patches comprises directing a jet of gas toward each respective patch of the array.
